(19) United States
(12) Patent Application Publication
(10) Pub. No.: US 2002/0000143 A1
(43) Pub. Date: Jan. 3, 2002

(54) MATERIAL JAM CLEARING IN AN IMPRESSION SYSTEM

(76) Inventor: FRANK OKONSKI, HARWOOD HEIGHTS, IL (US)

Correspondence Address: Barry W. Sulfrin, Esq., LAFF,WHITESEL & SARET, LTD, 401 N. Michigan Ave., Ste. 1700, Chicago, IL, 60611-4212, US

(21) Appl. No.: 09/185,041

(22) Filed: Nov. 3, 1998

Related U.S. Application Data
(63) Continuation of application No. 08/855,858, filed on May 12, 1997, now abandoned.
Application No. 08/855,858 is a continuation of application No. 08/536,702, filed on Sep. 29, 1995, now abandoned.
Application No. 08/536,702 is a continuation-in-part of application No. 08/419,184, filed on Apr. 10, 1995, now abandoned.

(51) Int. Cl. B26D 5/00

(52) U.S. Cl. 83/72; 83/344; 83/503; 83/506

(57) ABSTRACT

An automated material jam release system adapted for an impression system is disclosed in which various material presence sensing arrangements transmit “present” or “absent” signals that control automatic release and locking systems to either (a) remain in a first or operating position with a head holding an anvil in a predetermined position adjacent to a frame mounted die holder roller or (b) move to a second or open or jam release position where the anvil is not in an operating relationship to the roller. Movement of the head may be by various arrangements including (1) using a pair of actuators to respectively move an eccentric cam and release a spring; (2) using a single actuator such as an air cylinder mounted between the head and the frame to contract to hold the head in contact with the frame or automatically extend to lift the head from the frame and the corresponding anvil away from the die holder; and (3) using a single actuator to rotate an eccentric cam having a captured cam follower to positively move the head and anvil between and lock them in the two positions.

### RELATED APPLICATIONS

This application is a continuation in part of pending Ser. No. 08/855,858 filed May 12, 1997, which is a continuation of Ser. No. 08/536,702 filed Sep. 29, 1995, now abandoned, which is a continuation in part of Ser. No. 08/419,184 filed Apr. 10, 1995, now abandoned.

### FIELD OF THE INVENTION

The present invention relates generally to an impression system and particularly to a method and apparatus for jam detection and jam clearing in an impression system.

### BACKGROUND OF THE INVENTION

Impression systems comprising a die plate mounted on a die holder are utilized to process and finish predetermined patterns in sheet-like material typically found in web or blank form.

Typical die plates include perforating plates, scoring plates, embossing plates, cutting plates and the like. The die plate is attached to the die holder, sometimes called a die cylinder or drum. The die holder is usually cylindrical in shape. The die holder is mounted for rotation on a drive shaft synchronized with a conveyor system for the web or blank. As the web or bank enters the impression system from the conveyor system, it is moved between the die holder and an anvil which may take the form of a roller, which turns with the die holder roller, or a stationary bar called a widia bar. Clearance between the die holder and anvil is such that the die plate, integral with the die holder, contacts the web or blank for successfully impressing, embossing, cutting or the like. Each web or blank is thus brought into successive contact with the impression system, the drive shaft of the die holder synchronized with the conveyor system so that the die engages a different web or blank for each rotation of the die holder.

The conveyor system may be of a flat conveyor belt type, it may have transfer cylinders before and/or after the die holder which rotate cooperatively with the die holder, or it may be of any type which cooperates with the die holder. Using the transfer cylinders, the web or blank is transferred from the lead transfer cylinder to the die holder where it is processed and then transferred to the trailing transfer cylinder to be carried away from the die holder.

In the impression system, the die plate is accurately aligned and positioned longitudinally and circumferentially on the die holder in order to insure that the die plate accurately and repeatedly engages the web or blank.

In the art of the present invention, it is difficult to maintain the accurate alignment and positioning of the die plate as it relates to the web or blank due to wear, abrasion and shifting of the die plate over a period of time. As the accuracy of the alignment and positioning of the die plate degrade with continued use, the web or blank is caused to be out of position relative to the die plate. Although the die plate may be in its intended location, the conveyor system may also suffer from misalignment causing the web or blank to be misaligned when it is fed to the impression system; the alignment of the conveyor system for positioning the web or blank is not always accurate. Unfortunately, because of the close tolerances between the die plate and the anvil, when misalignment occurs between the die plate and the web or blank, the impression system cannot compensate for the misalignment resulting in jamming of the apparatus.

In the prior art, methods used to avoid or clear a jammed apparatus suffer from several drawbacks. The prior art procedure was typically manual and operator intensive, causing a very slow response time. That is, an operator continuously visually inspected the impression system until it jammed. When the impression system jammed, the conveyor system was manually shut down, with substantial lag time between the operator's visual acknowledgment of a jam, and the bringing of the conveyor system off line. The lag in the conveyor system's ability to respond quickly caused additional web or blank material to be lost by being jammed into the impression system, and backed up in the conveyor system.

When the impression system jammed, not only was there loss of web or blank material and sometimes damage to the cutting die, but the impression system down time caused loss of productivity. With an average of speed of the die holder of 1500 rpm, the operator's ability to visually detect and respond to a jam was slow in comparison to the feed rate of the web or blank (one web or blank is fed through the impression system with each revolution of the die holder). This slow response time meant that much more web or blank material would be pushed up into the impression system after the jam of a web or blank. The additional web or blank material increased the difficulty in clearing the path through impression system thereby increasing downtime and decreasing productivity. There is a resulting need for an impression system that detects and clears the material jams more efficiently.

Also, the mechanisms used in the prior art to open the roller hip to release pressure was typically manual and labor intensive, e.g., a pair of hold down clamps on each side of the head and rolls would have to be individually released.

### SUMMARY OF THE INVENTION

The present invention encompasses a material jam release and locking system for an impression system. The jam release system comprises a movable head having mounted thereon a roller or stationary anvil which head is coupled to a machine frame. A die holder rotatably mounted on the frame is in proximity to the movable head. In the preferred embodiment, the die holder incorporates a die that cuts, scores, or otherwise marks a material that is fed along a material path between the anvil and the die holder.

A sensor arrangement along the material path detects the material and provides a first signal in response to sensing the material. The sensor also provides a second signal when the material is not present.

A release and locking system including actuating means which may take the form of a pneumatic or hydraulic actuator cylinder is coupled to the sensor and the movable head. The hydraulic actuator of the release and locking system operates and moves the head away from the die holder in response to the first and the second signals indicating a jam condition. This automatic, immediate response minimizes or avoids loss of material, damage to dies and equipment, and enables the material jam to be detected and cleared quickly without waiting for operator intervention.

Several embodiments of the lifter are disclosed. In the first embodiment, a first activator rotates an eccentric cam from (a) a first position in which the outer surface of the cam bears against a hard surface to lock the head and cylinder in its normal operating position to (b) a second position in which the hold down pressure provided by the cam is released, thereby allowing a tension spring connected to a second actuator to move the head and top roller out of engagement with the cooperating roller.

In the second embodiment, a single actuator, having one ed connected to the frame and the other end connected to the head, holds the head in operating position until a jam is detected, after which it moves the head away from the frame to release a jam.

In a third embodiment, a single actuator also rotates an eccentric cam and moves a captured cam follower on the head between (a) a first position locking the head and roller into operating engagement with a second roller and (b) a second position in which the cam itself positively cams the head and roller and locks them out of operating position.

These and other aspects and attributes of the present invention will be discussed with reference to the following drawings and accompanying specification.

### BRIEF DESCRIPTION OF THE DRAWINGS

FIGS. 1A and 1B show a jam detection and clearing assembly for an impression system in accordance with a first embodiment of the present invention;

FIG. 2 shows a schematic of a jam detection and prevention method for an impression system in accordance with the present invention;

FIG. 3 shows a schematic cross-section of the present invention taken along line III-III in FIGS. 1A;

FIG. 4 shows a die plate of one embodiment of the sensing arrangement of the present invention;

FIG. 5 shows an elevational view and enlargement with parts in cross-section of a first embodiment of an automatic release and locking system for moving the anvil away from the die holder as shown in FIGS. 1A and 1B;

FIG. 6 shows another embodiment of a sensor arrangement in an automatic system for moving the anvil away from the die holder;

FIGS. 7A and 7B show a second embodiment of an automatic release and locking system for moving the anvil away from and toward the die holder;

FIG. 8 is a schematic illustration of another embodiment of the present invention using multiple sensors to determine the jam condition;

FIG. 9 is a perspective view of a third embodiment of a release and locking system for camming the head toward and away from the machine frame; and

FIG. 10 is an enlarged view of the body of the eccentric cam of FIG. 9 shown from the opposite side along lines X-X.

### DETAILED DESCRIPTION OF THE PREFERRED EMBODIMENT

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

Referring to the drawings, a jam detection and prevention method and apparatus for an impression system in accordance with the present invention is shown.

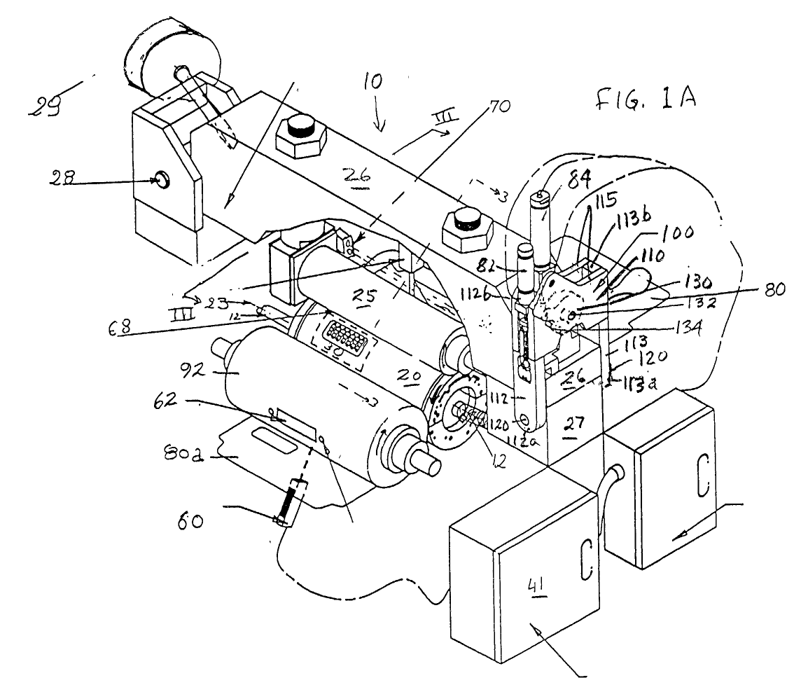

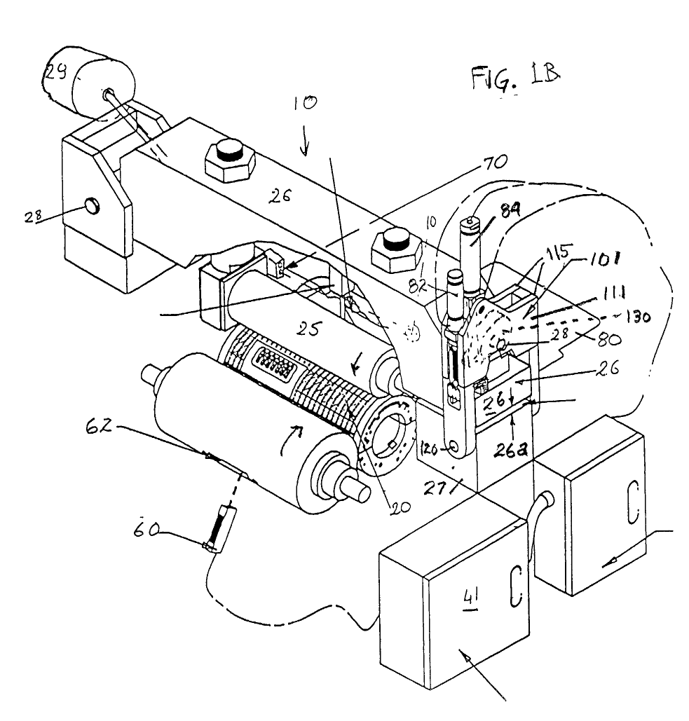

Referring to FIG. 1, a first embodiment of a jam detection and prevention apparatus 10 is shown. FIG. 1A shows the apparatus in a closed position while FIG. 1B shows the apparatus in a released or open position. A die holder 20 has a cylindrical shape and is mounted to a shaft 12 for rotation so that a die plate 30 mounted on holder 20 engages a web or blank material 80. The die holder 20 has a longitudinal axis 23 generally extending along the axis of the drive shaft 12 of a motor (not shown).

Typically, a different blank is engaged for each rotation of the die holder 20. However, alternate embodiments can use multiple dies on the die holder to engage each blank material multiple times.

Typical die plates 30 for processing a web or blank can comprise perforating plates for cutting perforation slots in the material, scoring plates for forming grooves in the material, embossing plates for pressing one side of a material to form a raised pattern on the opposing side of the material, and cutting plates for cutting a pattern in the material.

Although the invention is described using a cutting plate and blank material in the following embodiments, it will be appreciated that the invention is adaptable to any impression plate. Further, the invention is described in the embodiments as processing a blank material as the raw material, however, the invention is adaptable to a web or to a blank as the feed material.

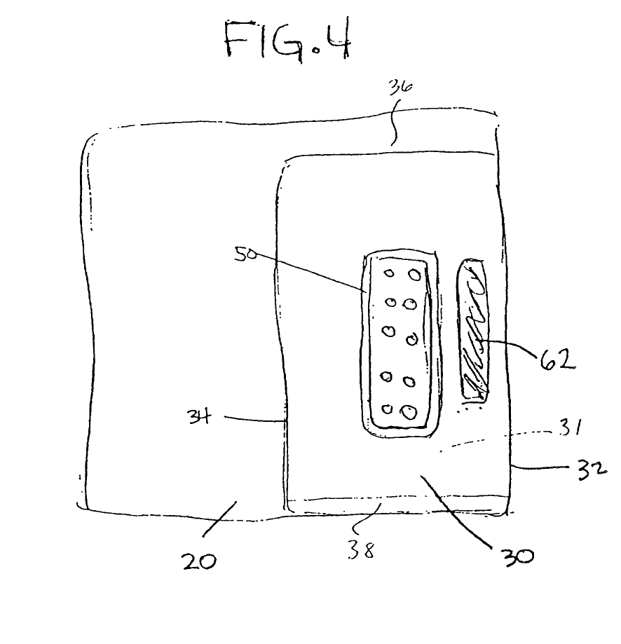

The die plate 30 is a flexible sheet of metal that is attached to the die holder 20. As shown in FIG. 4, the die plate 30 has a leading edge 32, a trailing edge 34, and opposing side edges 36 and 38. The die plate 30 has a surface 31 and a raised pattern surface 50 having a contour corresponding to the outline of the pattern to be formed in the blank. In the illustrated embodiment, the pattern surface 50 has a rectangular contour to cut a rectangular window panel from an envelope blank.

It will be appreciated that the pattern surface 50 may also have other appropriate shapes and patterns known to those skilled in the art including, for example, a pattern surface adapted to cut the sides of an envelope blank. The die plate 30 may be manufactured from any suitable material. The present invention extends to both magnetic and non-magnetic die holder systems.

Referring to FIG. 1A, an anvil in the form of roller 25 that is rotatably mounted on a head 26 which, in turn, is pivotally attached at one end to a frame 27. The roller 25 is located proximately to the die holder 20. In the preferred embodiment, this distance is measured in thousandths of an inch. Other embodiments use other distances depending on the thickness of the blank material being processed.

The anvil 25 can be a stationary, non-rotating widia bar, or can rotate complementary to the die holder 20 so that a blank (not shown) can be processed by contacting it with the cutting die plate 30 as the blank moves down the material path and between the die holder 20 and the anvil 25.

In the illustrated embodiment of the present invention, the anvil 25 is maintained in position at a fixed relative spacing from the holder during processing of the blank by the head 26. The head 26 is mounted on a frame 27, movable around a pivot point 28. The anvil 25 may be moved away from the die holder 20 by moving the head 26 around the pivot point 28, such as when the impression system is not in operation. A counterweight 29 is often added to the head 26 to facilitate and balance the movement of the head 26 around the pivot point 28.

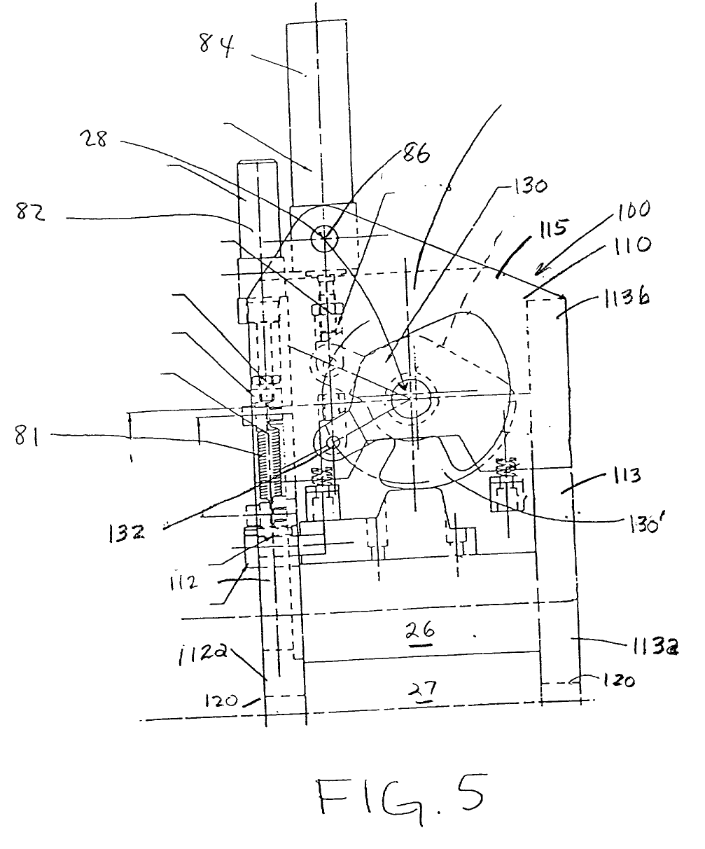

Details of the first embodiment of an automatic head release system of FIGS. 1A and 1B for moving the anvil away from the die holder is shown in FIG. 5. An actuator in the form of a pneumatic solenoid can be used to hold or push away the head from the lowered position responsive to the sensor detecting a jam condition and signaling an alarm.

In an automatic system for moving the anvil away from the die holder, as in FIG. 5, a pneumatic mechanical release for a jam detection and prevention system is shown. The anvil 25 is an integral part of the movable head 26 that is attached to a frame 27. The movable head 26 rotates about an axis 28 for moving the anvil 25 away from the die holder 20 (not shown).

The head releases structure 100 shown in FIGS. 1A and 1B includes an inverted U-shaped support 110 having a pair of pivot points 120 connecting the support 110 to the machine frame 27. Support 110 comprises a pair of legs 112, 113 having respective first ends 112a, 113a through which pivot point 120 pass to secure it to frame 27. Respective second ends 112b, 113b of legs 112, 113 have secured thereto on opposite sides a pair of plates 115 so that plates 115 are spaced apart by the width of the legs 112, 113. In the space between plates 115, there is provided an eccentric cam 130 rotatably mounted on a pivot pin 28. The pivot pin 28 is secured in and between the plates 115.

Cam 130 is pivotably connected to the second air cylinder actuator 84 at a pivot point 132. The actuator 84 in turn is pivotably mounted between plates 115 by a pivot pin 86 extending between plates 115.

In FIG. 5, the spring 81 is mechanically held in tension. When the jam detection of the present invention indicates a jam condition, a signal is sent to a solenoid valve (not shown) that may be pneumatic or electrical. The solenoid valve activates the air cylinders 82 and 84. The air cylinders 82 and 84 are interlocked and cooperate, the first cylinder 82 releasing the spring 81 and the second cylinder 84 moving a cam shaft to lift the head 26. The counterweight 29 facilitates the lifting of the head 26 upward, thus moving the anvil 25 away from the die holder. The automatic system for moving the anvil away from the die holder can be used with any of the jam detection systems of the present invention for automatic prevention of jams and damage to the die system.

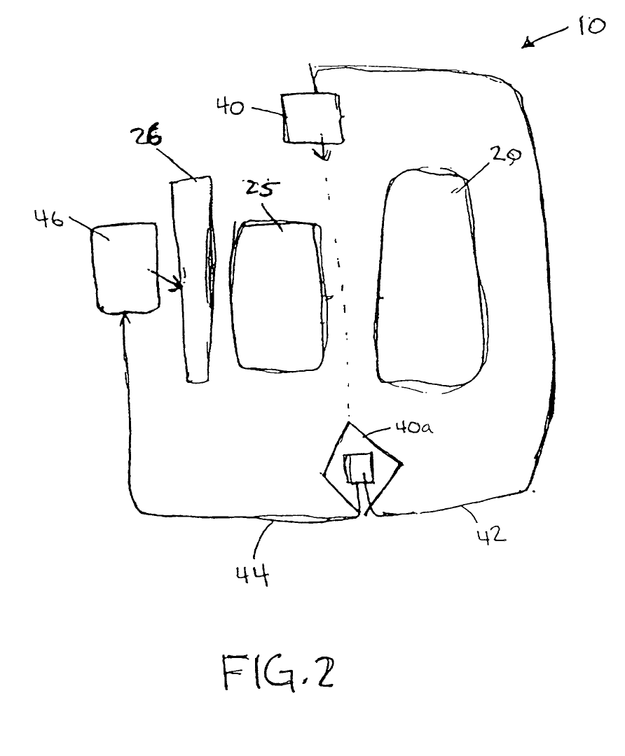

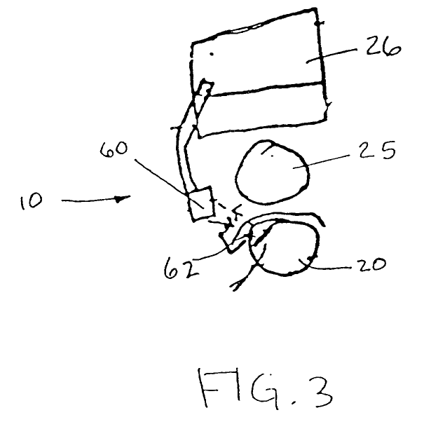

Referring next to the flow diagram of FIG. 2, depicting one embodiment of a method for automatic jam detection and prevention, in accordance with certain objectives of the invention, the apparatus 10 has a sensor 40 for sensing the leading portion of a blank 80 as illustrated in FIG. 3. The sensor 40 provides a first signal 42 when the leading portion of the blank is sensed and a second signal 44 when the leading portion of the blank is not sensed.

In an alternate embodiment of the invention, the first and second signals 42 and 44 are used to alert an operator that the system is either functioning properly or to take remedial action if necessary. This alert may take the form of lights or aural alarms to alert the operator.

The sensor 40 may be optical, so that sensing of the leading portion of a sufficiently opaque (or reflective) blank is by its interruption (or reflection) of an optical path. The optical sensor may use a light beam for sensing whether the material is present in the leading portion. Further, a light source and light receptive sensor 40a may be used to sense the leading portion.

The sensor 40 may be also be electrical, magnetic, or electro-mechanical so that the sensing of the leading portion of a sufficiently insulative blank is by its interruption of an electrical or magnetic circuit The sensor 40 may alternatively be mechanical, so that the sensing of the leading portion of a sufficiently thick blank is by its physical displacement of the sensing element of a mechanical sensor such as a lever or leaf.

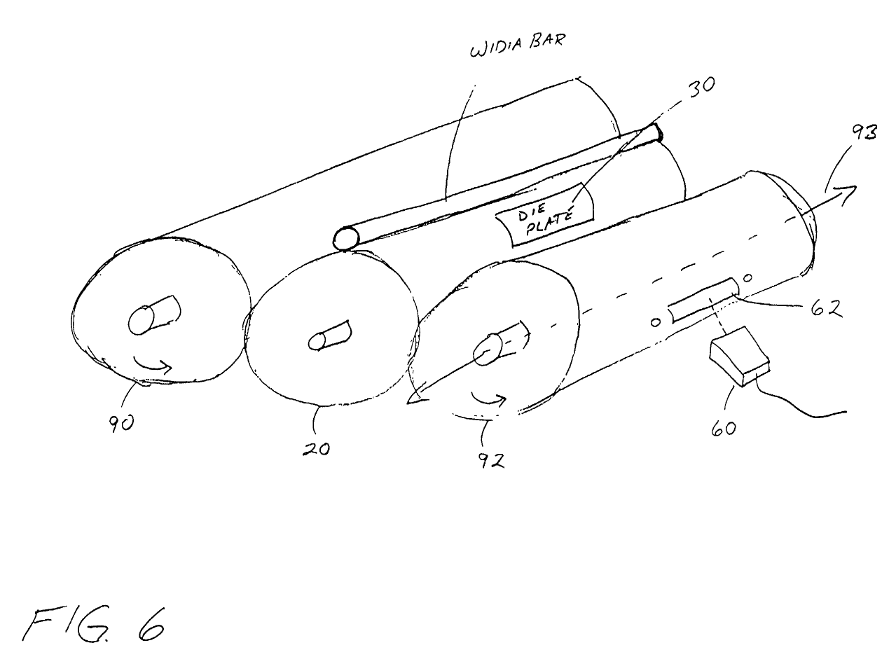

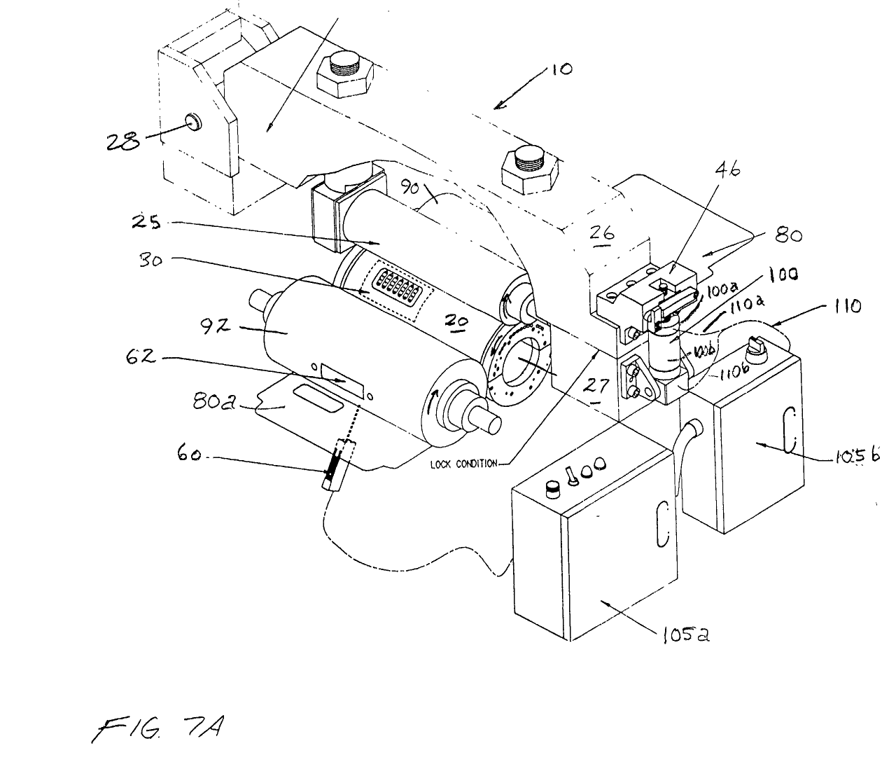

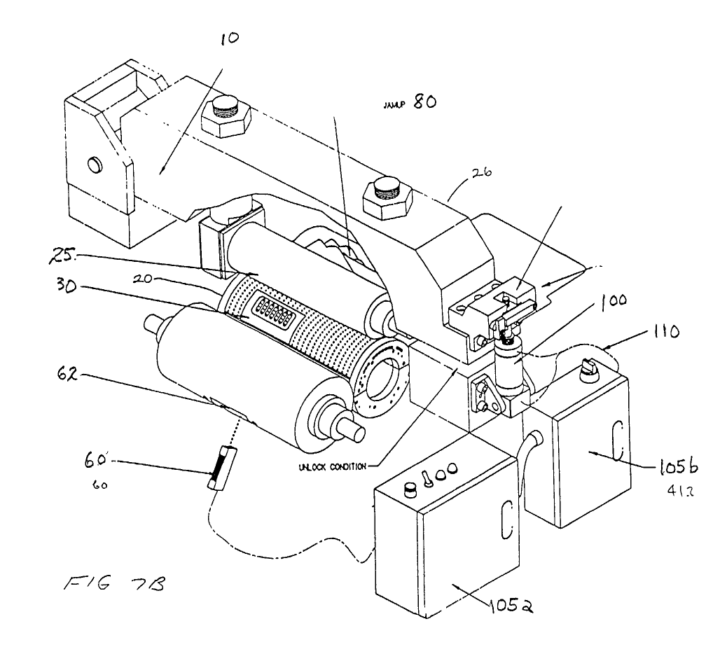

One embodiment of the present invention uses multiple sensors along a conveyor system having multiple anvil/die holder combinations. The multiple sensors may be all of the same type or a mixture of the various types. The sensors are distributed along the conveyor system and can be located in approximately the same positions as the sensors in the embodiments illustrated in FIGS. 1A&B, FIG. 6, and FIGS. 7A&B. Upon sensing a jam condition, any one of the sensors can stop the entire conveyor system and raise the particular anvil involved in the jam away from the die holder. In another embodiment, all of the anvils in the conveyor system are raised away from all of the die holders.

Referring to FIG. 2, for a jam detection and prevention system, the second signal 44 communicates with a moving means 46 for moving the head 26 and anvil 25 away from the die holder 20.

As illustrated in FIGS. 3 and 4, a piece of reflective tape 62 is located ahead of the leading portion 52 of the die plate 32. The reflective tape 62 is adhered to and becomes integral to the die plate 30 and rotates with the die plate 30 and die holder 20.

An optical sensor 60 is positioned to align with the reflective tape 62 for sending and receiving an optical signal from the reflective tape 62 each time the reflective tape is left uncovered as it rotates around the axis 23 of the die holder 20. Alternatively, the tape 62 can be non-reflective, while the web or blank is reflective (relative to the tape), so that failure to detect a reflected light signal indicates a jam condition alarm.

Similar to the embodiment illustrated in FIG. 2, the sensor 40 in the FIG. 3 embodiment is comprised of the optical sensor 60 and the reflective tape 62. During normal operation of the impression system, a blank is processed with each rotation of the die holder 20. The leading portion of the blank moves in and across the die plate 30 toward the leading portion of the die plate 32 thereby covering the reflective tape 62. The optical sensor 60 detects the presence of the blank (by the lack of a signal from the reflective tape 62), thus providing a first signal 42 responsive to sensing the leading portion of the blank. The optical sensor 60 detects the absence of the blank by receiving a signal generated by the optical path between the optical sensor 60 and the reflective tape 62 thus providing a second signal 44 responsive to not sensing the leading portion of the blank.

In another embodiment, the sensor 10, shown in FIG. 1, is comprised of an optical sensor 70, a mirror 10, and a signal processor 41 that interprets the responses of the optical sensor 70. The optical sensor 70 sends a light beam to the mirror 10 that reflects it back to the sensor 70. The beam is in the same plane as the clearance area 68 between the die holder 20 and the anvil 25 along the length of the clearance area 68.

As a blank is fed through the impression system for processing, it will move into and through the clearance area 68. With each rotation of the die holder 20, one blank is processed through the impression system.

The optical sensor 70 detects the presence of the blank when the blank blocks the optical path along the length of the clearance area 68, and provides a first signal responsive to sensing at least the leading portion of the blank. The optical sensor 70 detects the absence of a blank when the optical path along the length of the clearance area 68 remains undisturbed thereby providing a second signal responsive to not sensing the leading portion of the blank.

The first signal and the second signal are communicated to the signal processor 41 for interpretation. An automatic response mechanism provides communication to an operator, and/or automatically separates the anvil (or widia bar) from the die holder when interpretation by the signal processor 41 indicates a jam condition.

In accordance with certain objects of the invention, the detection by the present invention of the absence of a blank may indicate that there is a failure of the conveyor system. It may also indicate that feed material has jammed upstream of die plate processing or that the web has broken. Detection by the present invention of the continuous and uninterrupted presence of feed material in the clearance area 68 after the die holder may indicate that feed material has jammed between the anvil 25 and die holder 20, or that the die holder 20 or anvil 25 are not rotating properly.

To avoid damage to the die plate and other parts of the impression system, loss of raw materials and downtime, the automatic jam prevention system can be implemented to receive the first and second signals 42 and 44 from the sensor 40, diagnose the problem (from the signals 42 and 44 being analyzed and determined to be out of normal range of operation), and cause the impression system to respond to correct the problem or prevent jamming and damage. The diagnosis can be of time since the last of the first and/or second signal, relative timing of the first and second signals, or absolute timing of the first and second signals.

Referring now to FIG. 6, there is schematically shown another embodiment of the present invention for jam detection. In FIG. 6, the conveyor system has transfer cylinders 90 and 92 located before and after the die holder 20, respectively. The transfer cylinders 90 and 92 rotate cooperatively with the die holder 20 having a die plate 30.

The lead transfer cylinder 90 transfers the web or blank to the die holder 20 where it is processed and onto the trailing transfer cylinder 92 to be carried away from the die holder 20. In this alternate embodiment, the sensor 60 is placed next to the trailing transfer cylinder 92. The sensing of the leading portion of a blank occurs after the blank has been processed and has passed beyond the die holder 20.

A piece of reflective tape 62 is located on the trailing transfer cylinder 92. The reflective tape 62 is adhered to and becomes integral with the trailing transfer cylinder 92. The optical sensor 60 is positioned to align with the reflective tape 62 for sending and receiving an optical signal from the reflective tape 62 each time the reflective tape is left uncovered as it rotates around the axis 93 of the trailing transfer cylinder 92. The tape 62 may also be non-reflective with a reflected signal from the web or blank to the optical sensor 60 indicating a jam condition.

FIGS. 7A and 7B illustrate a second alternate embodiment of the automatic head release. Using an air cylinder 100, this embodiment raises the head 26 or anvil 25 from the lock position, illustrated in FIG. 7A, to the released position, illustrated in FIG. 7B.

Using the jam detection process of the present invention, with the second embodiment of the automatic head release system, a material jam signal from the sensor 60 signals the electronic control box 105 to instruct the air control box 110 to increase air pressure in the upper portion 100a of air cylinder 100. The air control box 110 has an air valve (not shown) that controls the flow of the air between the air lines, so that air pressure may be fed alternatively to a top portion 100a of cylinder 100 through line 100a to urge a piston therein down to force head 26 against frame 27 or to feed air through 110b to a lower part 100b of cylinder 100 to urge the piston (not shown) upwardly and thereby move head 26 away from frame 27 to avoid the jam. In other embodiments, both the electronic control box 105 and the air control box 110 can be combined into one box.

The increase in pressure in the air cylinder 100 raises the anvil 25 or the head 26 away from the die holder 20. Once the jam condition has been cleared, the air pressure is decreased in line 110b and increased in line 110a, and the air cylinder 100 lowers the head 26 or anvil 25 back to the lock position.

The embodiment illustrated in FIGS. 7A and 7B can use fluids other than air, such as hydraulic fluid, to raise and lower the head 26 or anvil 25. Additionally, the head 26 may be configured with levers and/or a cam such that increasing the fluid pressure in the cylinder 100 moves the head 26 to the lock position and decreasing the pressure moves the head 26 to the open position.

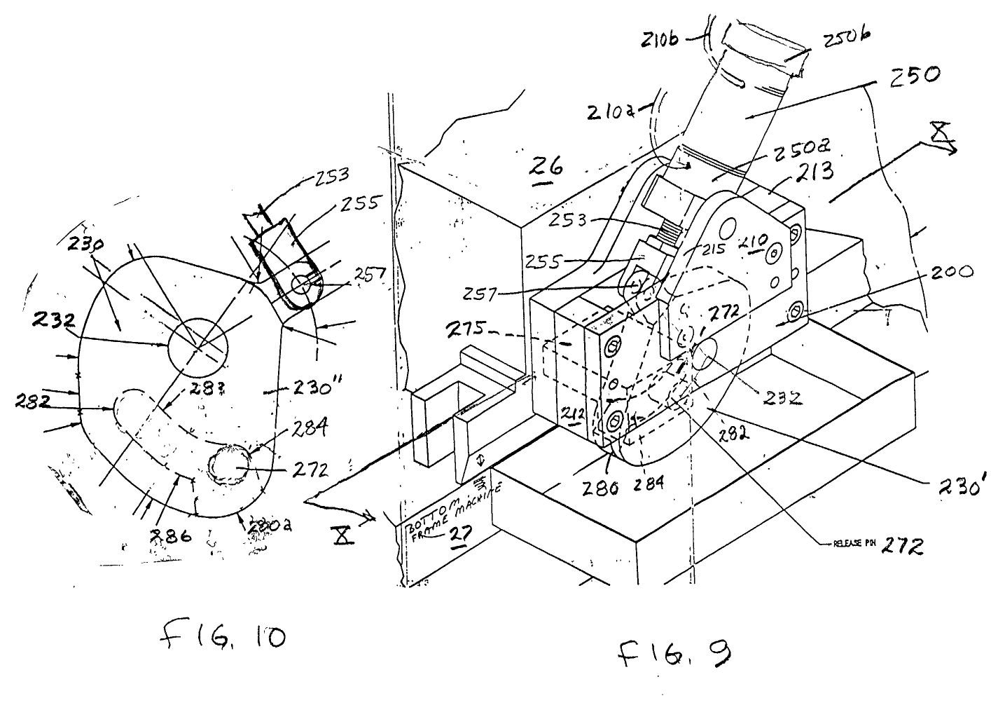

A third embodiment of a head release and lock is represented in structure 200 as shown in FIGS. 9 and 10. This structure 200 includes a support 210 attached to the machine head 26. The support 210 supports an eccentric rotatable cam 230 which is moved by an actuator 250 between a first closed operating position 230. As shown in FIG. 9 in which a release pin 272 mounted on the frame 27 is cammed at or near an inner end 282 of a cam recess 280 and a second released position 230″ in which the release pin 272 is cammed to an open end 284 of the cam recess 280 and forces the head 26 to be spaced away from machine frame 27. In this position as shown in FIG. 10, it may be understood that the cam opening 280 allows the whole head 26 to be raised vertically about pivot 28 without interference from the cam.

Cam opening 280 includes an upper surface 283 which bears against the top of release pin 272 as actuator 250 rotates cam 230 counterclockwise, as shown in FIG. 9, to cam head 26 positively upwardly and open the space between head 26 and frame 27. Conversely, during clockwise movement, as shown in FIG. 9, a lower camming surface 286 bears against release pin 272 to positively mechanically lock the head 26 in a precise predetermined position whereby the anvil/widia bar is positively locked in a rigidly fixed predetermined position relative to the die roller 20. This precise positively fixed relationship has been found to produce improved die cutting results over all other known head release structures. Moreover, it is less expensive to manufacture and has a more efficient operation.

As shown in FIG. 9, the release pin 272 projects from a block 275, shown in dotted lines, that is secured to frame 27. In response to a possible jam signal, air or fluid under pressure is fed through lines 210b to the upper end 250b to move an interior piston down and the cam 230 counterclockwise, as shown in FIG. 9, to a position 230″, as shown in FIG. 10. When the head 26 is to be returned to its operating position, air or fluid under pressure fed through line 210a to lower end 250a moves cam 230 clockwise to position 230″.

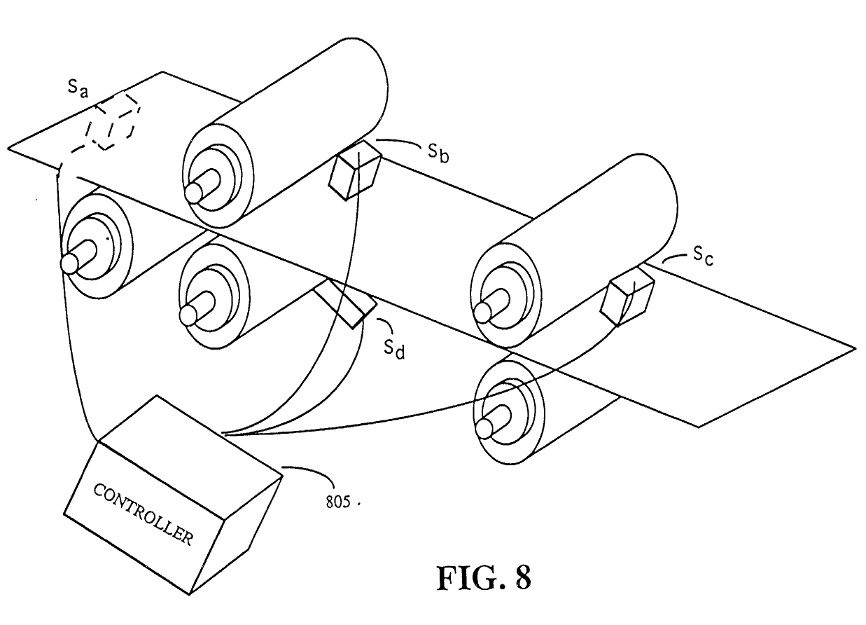

The multiple sensors Sₐ, S_{b}, S_{c}, and S_{d} of one embodiment of the present invention are shown in FIG. 8. The sensors are distributed along the material path to sense the jam condition. The sensors can be mounted above or below the material path. Additionally, the sensors can be distributed such that some of the sensors are above the material path S_{b}, S_{c} and others are below Sₐ, S_{d}.

In the preferred embodiment, the sensors operate such that one sensor, for example Sₐ, shuts down the material path and raises the anvil away from the die holder. In alternate embodiments, the sensors work in conjunction with each other to cause the material path to stop and the anvil to be raised away from the die holder.

An alternate embodiment might include one sensor working together with at least one other sensor. An example of such an embodiment is that two sensors, such as S_{b} and S_{d}, in sensitive areas of the material path agree that the material is jammed. Another alternate embodiment uses all the sensors working together. An example of such a case is that all of the sensors agree that the material is jammed and the material path should be shut down. Other embodiments use other combinations of the number and position of the sensors to determine when to shut down the material path and raise the anvil away from the die holder.

As in the other embodiments, the sensors of the embodiment of FIG. 8 are coupled to a controller 805. The controller 805 interprets the signals from the required sensors to determine if the material has jammed. The controller 805, either by itself or with other controllers, instructs the material path to stop and raises the anvil away from the die holder to clear the jammed material.

Examples of typical controllers that are used by the present invention include microprocessors such as Intel's 80XXX family and Motorola's 680XX family. Additionally, microcontrollers such as an Intel 8020 or a Texas Instruments SN74LS481 can be used. Other controllers of various speed and complexity can be used while remaining within the scope of the present invention.

It can be seen that a method and apparatus for jam detection and prevention have been provided that attain the aforementioned objects. Although the structure and operation of the apparatus has been described in connection with the cutting of paper-like material, and as to illustrated embodiments, it is not intended that the invention be limited to such operations. Various additional modifications to the specifically illustrated and described embodiments of the invention will be apparent to those skilled in the art, particularly in light of the teachings of this invention.

The invention may be utilized in the formation of any pattern in any thin and flexible sheet-like material, including, for example, paper, cloth or plastic materials to form envelopes, labels, sanitary napkins, window patterns and the like. It is intended that the invention cover all modifications and embodiments which fall within the spirit and scope of the claimed invention.

What is claimed is:

1. A material jam detection and release system comprising:
a first transfer roller parallel to and upstream of a rotary die holder;
a second transfer roller parallel to and downstream of the rotary die holder;
an anvil mounted on a movable head and being adjacent and parallel to said rotary die holder, said head having first and second spaced ends, said head frame being pivotally movable about said first end and having a lock and release means on said second end;
a material feedpath initially passing said first transfer roller, next passing between said rotary die holder and said anvil, and subsequently passing said second transfer roller, such that fed material is adapted to be moved from the first transfer roller to the rotary die holder, said rotary die holder being adapted to feed said fed material between the anvil and the removable die plate to thereby cut a pattern in said material and further adapted to pass the cut material to said second transfer roller;
a first sensor, positioned in said material feedpath upstream of said movable head and downstream of said first transfer roller, adapted to detect a leading edge of said fed material within said feedpath proximate said movable head, said first sensor providing a first signal in response to sensing said leading edge of said fed material;
a second sensor in said feedpath downstream of said second roller for detecting the absence of said cut material on said second transfer roller; and
an actuator responsive to signals from said first and second sensors to lift said second end of said head away from the die holder in response to the first sensor detecting the leading edge of said material in said feedpath proximate said rotary die holder and said second sensor indicating absence of said material on said second transfer roller.

2. The system of claim 1, wherein said first sensor comprises an active signal transmitter disposed at said first facing side of said machine frame and a passive signal transmitter disposed at said second facing side of said machine frame.

3. The system of claim 2, wherein said active signal transmitter comprises an optical sensor and said passive signal transmitter comprises a mirror for reflecting an output from said optical sensor.

4. The system of claim 1, wherein said second transfer roller comprises sensor reflective means for reflecting an output of said second sensor and said second sensor comprises means for optically sensing said reflected output.

5. The system of claim 1, wherein said sensor reflective means comprises reflective tape.

6. The system of claim 1, wherein said lifter apparatus comprises a pneumatic lifter apparatus.

7. The system of claim 1, wherein said anvil comprises a widia bar.

8. The system of claim 1, wherein said first sensor comprises an active signal transceiver disposed at a predetermined location of said machine frame, and a passive signal transceiver disposed at a predetermined location of said rotary die plate such that said first sensor senses presence of said material at said rotary die plate.

9. The system of claim 8 wherein said active signal transceiver comprises an optical sensor and said passive signal transceiver comprises means for reflecting an output from said optical sensor.

10. The system of claim 9 wherein said means for reflecting an output from said optical sensor comprises reflective tape.

11. The system of claim 8, wherein said hydraulic lifter apparatus lifts the head at said second end thereof, away from the die holder in response to said first sensor indicating presence of said material proximate said rotary die holder and said second sensor indicating absence of said material on said second transfer roller.

12. The system of claim 9, wherein said lifter apparatus comprises pneumatic lifter apparatus.

13. In an impression system for cutting patterns in material, said system comprising a machine frame disposed with at least one transfer roller and a rotary die holder, wherein a material is fed along a feedpath that flows downstream from at least one said transfer roller to the rotary die holder, a material jam detection and release system comprising:
a first transfer roller parallel to and upstream of the rotary die holder;
a second transfer roller parallel to and downstream of the rotary die holder;
a movable head comprising first and second ends, said first end having hinging means for coupling to a first facing side of said machine frame, said second end releasably attaching to a second facing side opposite said first facing side of said machine frame, said movable head further comprising a bar that acts as a stationary anvil relative to said movable head;
said jam detection and release system further comprising a die plate removably mounted to said rotary die holder in rotational proximity to the movable head and said anvil, a material feedpath beginning with the first transfer roller and ending after the second transfer roller such that fed material is carried by the first transfer roller to the rotary die holder, said rotary die holder thereby feeding fed material between the anvil and the removable die plate to cut a pattern in said material and feed the pattern cut material to said second transfer roller;
a sensor positioned in said feedpath upstream of said movable head and downstream of said first roller for detecting a leading edge of said material within said feedpath proximate said movable head, said sensor providing a signal in response to sensing said leading edge; and
an hydraulic lifter apparatus, coupled to said sensor and said movable head, said hydraulic lifter apparatus lifting the head at said second end thereof, away from the die holder in response to the sensor indicating absence of said material in said feedpath proximate said rotary die holder.

14. An impression system comprising a head supporting a first roller and a frame supporting a second roller, said first and second rollers being movable with respect to each other from a first position in which said rollers are in a fixed predetermined operating relationship to each other and a second position in which said rollers are separated and not in operating relationship;
a release and locking system for moving said rollers between said first and second positions, said system comprising a rotatable body having an eccentric cam groove with first and second camming surfaces, whereby rotation of the body in first and second rotary directions will move a cam follower in said groove in first and second linear directions, respectively, said cam follower being mounted on one of said head or frame and said body with said cam groove being mounted on the other side of said head or frame, whereby movement of said groove in a first rotary direction will cause a first cam surface of said groove to bear on a first surface of said follower and positively lock said rollers in a precise predetermined fixed operation position with respect to each other and movement of said groove in a second rotary direction will cause a second cam surface of said groove to bear on a second surface of said follower and positively move said rollers away from each other to said second position.

15. An impression system according to claim 14, including jam sensors causing said groove in said body to move from said first operating position to said second released position.

16. An impression system according to claim 14, wherein said grooves are spaced apart a distance substantially equal to the distance been said first and second surfaces of said cam followers.

17. An impression system according to claim 16, wherein said first and second groove surfaces are substantially parallel.

18. An impression system according to claim 14, wherein said groove opens at an edge of said body whereby said follower does not engage said groove and retrain movement of said head when said groove is in its second position.

19. An impression system according to claim 14, wherein said cam follower is a pin mounted on said frame and said body having said groove is mounted on said head.
